(19) United States
(12) Patent Application Publication
(10) Pub. No.: US 2018/0251983 A1
(43) Pub. Date: Sep. 6, 2018

(54) BIRD CAP

(71) Applicant: Bal HEO, Alpharetta, GA (US)

(72) Inventor: Bal HEO, Alpharetta, GA (US)

(21) Appl. No.: 15/446,232

(22) Filed: Mar. 1, 2017

(51) Int. Cl. E04D 13/00; E04B 1/72; A01M 29/32

(52) U.S. Cl. CPC E04D 13/004; A01M 29/32; E04B 1/72

(57) ABSTRACT

Bird caps, which are devices installed at the highest elevations of the peaks of gabled roofs so as to prevent damage caused by the roosting habits of birds. Exemplary bird caps of the invention each comprise a peak formed by angularly connected side panels, opposed and adjustable face panels that may be moved apart or together to adjust the angle at the peak, a tail portion and a tail plate, each of which provides a further covering function to the area around a roof peak. In certain embodiments, the device includes hooded panels which further enhance the roof peak protection provided. Also disclosed are methods of preventing the bird damage and deterioration at the peak edges of a roof.

### TECHNICAL FIELD

This application relates to devices and methods for preventing pecking damage by birds at elevated roof points of shingled roofs.

### BACKGROUND

Roofing may be constructed of various materials, examples of which include asphalt shingles, composite shingles or panels, or metal panels. The roof is an expensive investment in residential or commercial construction, and roofing installations are expected to last for up to several decades. Because of its elevation and exposure, the roofs are susceptible to environmental damage from extreme weather conditions such as high winds, prolonged layering of ice, snow weight and hail. These elements cause the roofing materials to be eroded or to become dislodged at installation points and the seams so that the impermeability of the roof construction is breached, and the resulting ingress of water and pests becomes a further source of damage. Pest damage is another significant cause of roofing loss or early deterioration. In particular birds, as their habit, seek out elevated perches and often choose the eaves, i.e. the edges of a roof which overhang and project beyond the walls that form the sides of a building, and the peaks and ridges of the roof, which are the high points at the intersections of roofing panels on a pitched roof. While the birds use these points of elevation as perches, they also nibble on particles from the roof, for example pebbles of asphalt from the shingles. Eating small indigestible particles aids the birds' digestion. This bird behavior is ubiquitous and a major factor in the characterization of birds as pests by the construction industry. Their continued pecking at the edges of the eaves and ridges cause a gradual, premature deterioration of the roofing materials over time, which is referred to herein as “bird damage.” In addition, the plucking away at these exposed areas of the roof can create openings through which birds and other pests can enter and create undesirable and unsanitary nests beneath the roof covering. Birds may also build nests that block ventilation systems within the building and also impede ventilation of the roof itself. The weight of droppings from birds nesting beneath a building roof can cause ceiling collapse. The presence of birds on the roof also increases the level of noise which may be a nuisance to building occupants. Further, bird droppings contain uric acid, and at a pH of from about 3 to 4.5, the acidity can eat through most roofing materials. The droppings also create an unsightly appearance on the roof surface.

The methods that have been used to deter bird roosting on sensitive roofing areas have involved using repellent structures and materials or limiting physical accessibility to the roof elevations. According to the International Association of Certified Home Inspectors, owners of commercial buildings, which can suffer extensive bird damage at great financial losses, have resorted to devices such as bird spikes which involve installing numerous metal wires or spikes close together to form a porcupine-like arrangement pointed wires that discourage bird landings. An electric low-voltage current may also be run through the wires. These are expensive methods as the wires and electrical systems are difficult and time-consuming to install, and the obvious appearance on the roofing profile, especially in the case of residential roofing, is undesirable. Alternatively, scare devices such as balloons or animal images or characters can for a while deter bird approach; however after a while the birds overcome their apprehension at the presence of a static figure. The deterrent effect is reduced and the problem resumes. Another deterrent method includes applying a repellent liquid or paste to the roofing surface. These methods will require continual reapplication for the deterrent effect to be persistent. The foregoing bird repellent systems require significant additional expense and their effect is not permanent.

There is therefore a need in the field of roofing materials and installation for apparatuses, materials and methods that prevent roosting of bird pests, or alternatively prevent the damaging effects of bird roosting at the elevation points of roofs. Preferably, the needed solution would provide a protective covering that is durable, impermeable and made of a material than cannot be nibbled away by the birds themselves or otherwise eroded or degraded over time by environmental exposure. Further, such a solution should desirably provide protection over all the outermost elements of eave and ridge edges at the high points of a roof to provide a protective covering against the damage from bird perching. The most practical solution should also minimize the installation process and the need to puncture the roof materials with nails, which could lead to seepage of water beneath the shingles and into the building structure. Such a solution is presented by the apparatuses and methods of the present invention.

### SUMMARY OF INVENTION

The present invention comprises a bird cap that includes two side panels, each further including a front edge, a top edge and a side edge, wherein the two side panels are joined at the top edges thereof at an angle to form a peak; two face panels, each of which is attached to the front edge of one side panel, wherein the two face panels intersect at an intersection area, and further wherein the two face panels move cooperatively one in relation to the other to narrow or widen the angle of the peak; a tail portion which is formed as an extension of the side panels distally from the face panels, and wherein the length of each side panel is progressively shortened in relation to the length from the front edge to the tail portion; and a tail plate formed as the distal end of the tail portion. The bird cap further comprises an attachment means for fastening the bird cap to the peak of a gabled roof. In other embodiments, the bird cap comprises hooded panels that overhang the face panels at the peak of the bird cap. The hooded bird cap so formed provides additional protection to the roof peak by creating an extension that protrudes horizontally out and away from the face panels and the side walls of the building structure beneath the roof peak. This in turn further removes access by roosting birds to the materials of the roof peak.

The invention further comprises a method of preventing bird damage at a roof peak comprising includes the steps of measuring the angle at the front of a roof peak; placing a bird cap over the front of the roof peak, the bird cap being comprised of: two side panels, each comprising a front edge, a top edge and a side edge, wherein the two side panels are joined at the top edges thereof at an angle to form a peak; two face panels, each of which is attached to the front edge of one side panel, wherein the two face panels intersect at an intersection area, and further wherein the two face panels move cooperatively one in relation to the other to narrow or widen the angle of the peak; a tail portion which is formed as an extension of the side panels distally from the face panels, and wherein the length of each side panel is progressively shortened in relation to the length from the front edge to the tail portion, the tail portion terminating a flex zone; and a tail plate formed as the distal end of the flex zone; wherein the tail plate is aligned over the roof peak; and attaching the bird cap to the roof peak at the intersection of the two face panels.

### BRIEF DESCRIPTION OF DRAWINGS

FIG. 1 is a planar side view of a bird cap according to the invention.

FIG. 2 is a top perspective view of a bird cap according to an exemplary embodiment of the invention.

FIG. 3 is a perspective view of a front view of the invention.

FIG. 4 is a photograph showing bird caps according to the invention in relation to a roof peak.

FIG. 5 is a planar representation of a multi-gabled roof installed with bird caps according to the invention.

FIG. 6 is a front perspective view of an alternate embodiment of the invention comprising a hooded peak element.

FIG. 7 is a photograph of a bird cap with a hooded peak according to an embodiment of the invention.

### DESCRIPTION OF EMBODIMENTS

Bird caps of the invention each comprise a peak formed by angularly connected side panels, opposed and adjustable face panels that may be moved apart or together to adjust the angle at the peak, a tail portion and a tail plate, each of which provides a further covering function to the area around a roof peak. The bird cap is formed with acute angle at the edge of the front side walls that form the peak of the bird cap and which overhang and overlap the side wall of a roof gable. The devices characterized in this disclosure present a further improvement over the device described and claimed in co-pending U.S. application Ser. No. 15/004,947. The presently claimed device comprises two side panels that are curved and tapered from the front edges thereof toward the back, to form a tail portion. These same side panels are conjoined at their upper edges to form a peak, and the front edges of the side panels taper backward down from this peak so that the side profile of the peak itself is acutely angled downward toward the ends of the lower edges of the side panels.

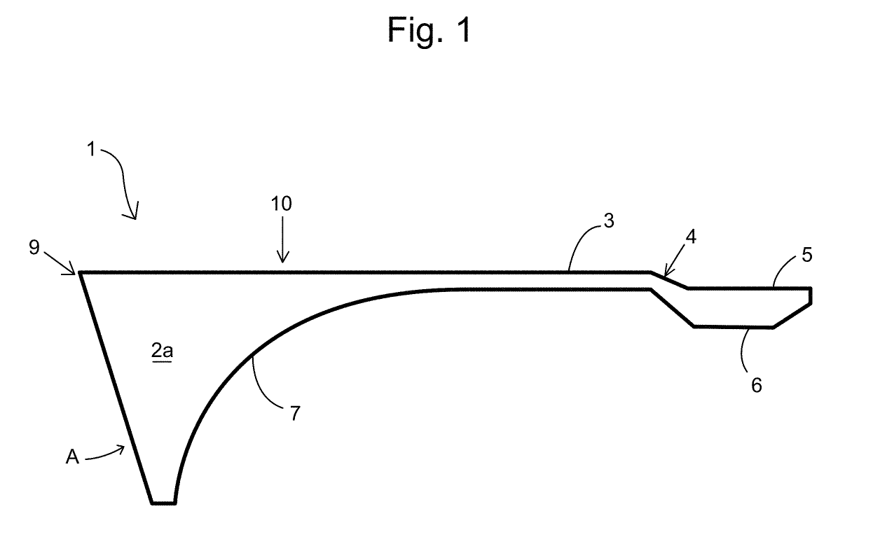

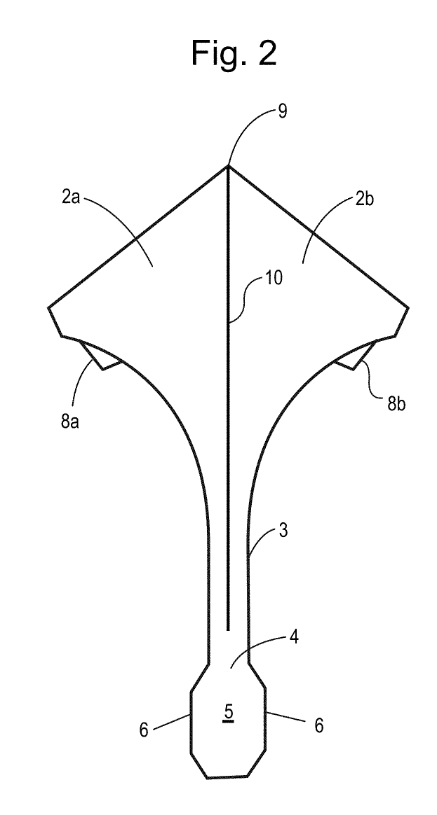

A bird cap 1 of the invention is shown in FIG. 1. This embodiment comprises side panels 2a, 2b (each shown in FIG. 2) which are joined at their top edges to form a peak 9. The front edges of the side panels 2a, 2b are angled beneath the peak 9 to form an acute angle A such that the tip of the peak 9 juts out above the front edges of the side panels 2a, 2b. In this manner, when the bird cap is placed over the roof peak there is an area of displacement created between the peak of the bird cap and the roof peak itself. The side edges 7 of the side panels are curved or angled to taper upward toward the peak, forming a tail portion 3. The tail portion 3 terminates in a somewhat bendable flex zone 4, which is attached to and continuous with a tail plate 5. The tail plate 5 may further optionally comprise side flanges 6 on either side thereof which hang over the ridge of the roof gable when the bird cap 1 is installed. FIG. 2 is a top view of a device according to the invention which shows the ridge 10 formed by the joint between the side panels 2a, 2b. The ridge 10 continues from the peak along the length of the tail portion, which then flattens out at a flex zone 4. The flexible zone 4 extends to the tail plate 5, which is substantially flat in relation to the ridge 10; however the sides of the tail plate in this embodiment are formed into flanges 6 which can be bent over the roof ridge during installation of the bird cap. The face plate 5 can be formed as an angular or spherical shape, provided that the width of the face place is wider than the narrowest width of the tail portion 3 proximate to the flex zone 4. The flex zone in the various embodiments of the invention is the transition point between the tail portion 3 and the tail plate 5. The flex zone 4 is narrower than the tail plate and may be of the same width or narrower than the segment of the tail portion 3 that is most distally located from the face panels 8a, 8b. Because of its carefully and particularly determined location and size, the flex zone 4 is thus engineered to be susceptible to bending, deflection or displacement by the particularly directed application of pressure through an angle of displacement at points near the peak of the bird cap and through the proximately located tail portion.

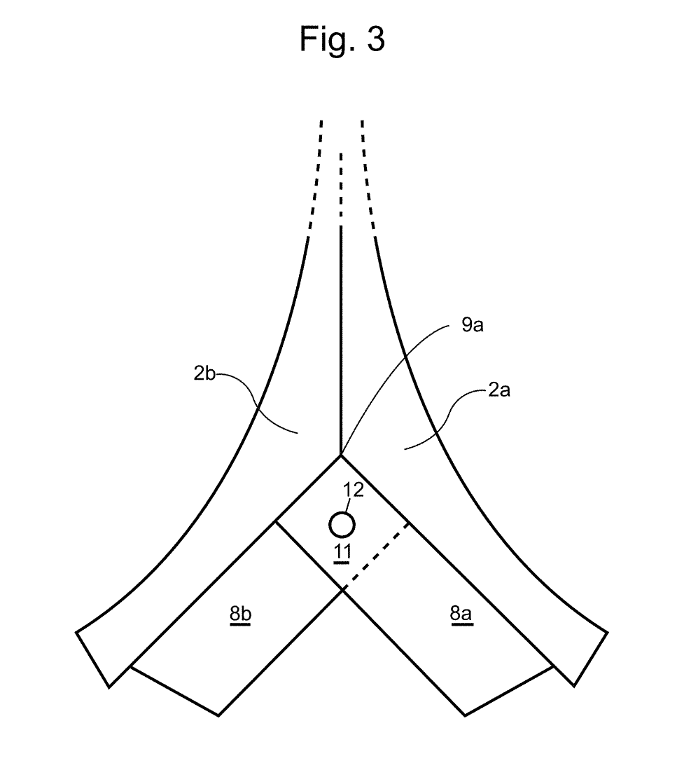

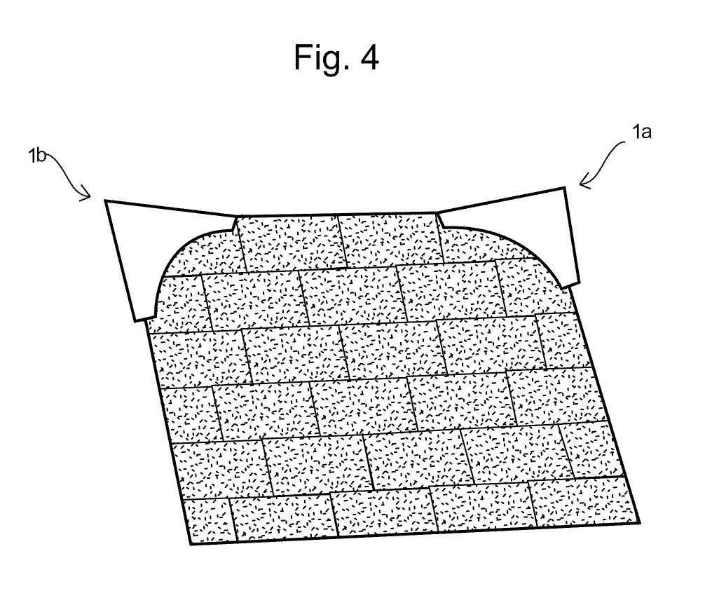

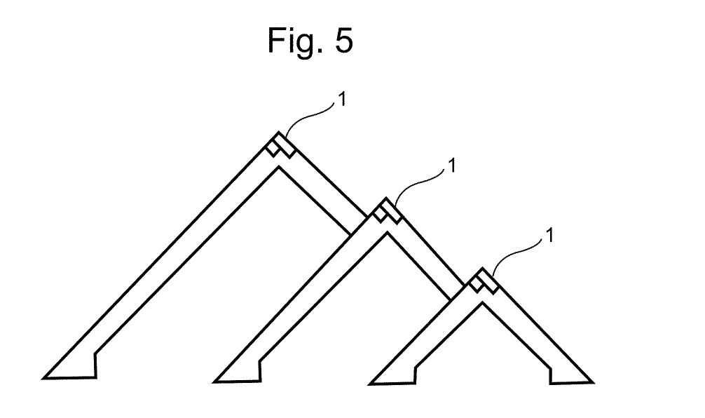

In FIG. 3, face panels 8a, 8b are attached to the front edges of the side panels 2a, 2b. The face panels 8a, 8b independently move in relation to each other and intersect beneath the peak 9. An intersection area 11 is defined by the point of overlap between the side panels, and it is this intersection area that provides the only point of attachment for affixing the bird cap to the roof. Moving the panels 8a, 8b apart decrease the intersection area and widen the peak angle of the bird cap, while moving the panels 8a, 8b closer together increase the intersection between the panels and narrow the peak angle. In this manner, the angle of the bird cap can be adjusted to correspond to the angle of the roof peak over which it is being installed. FIG. 4 is a photograph showing a bird cap la according to the invention which has been attached according to the method of the invention with displacement of the cap's peak imposed through the frontal angle A (FIG. 1) which projects the peak out from the roof peak itself. In this figure, a similarly constructed bird cap 1b was not attached with angled downward displacement according to the method of the invention, and accordingly the tail portion and tail plate are deflected upward. FIG. 5 depicts a residential roof with multiple roof gables fitted with the bird caps of the invention. In this respect, the bird caps of the inventive concept serve an ornamental as well as a functional purpose.

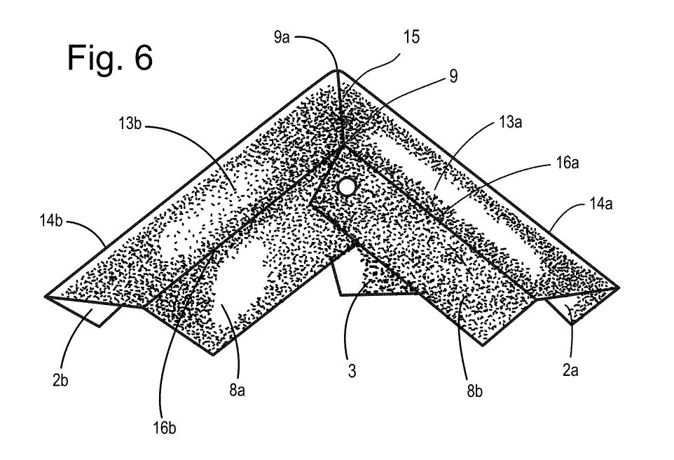

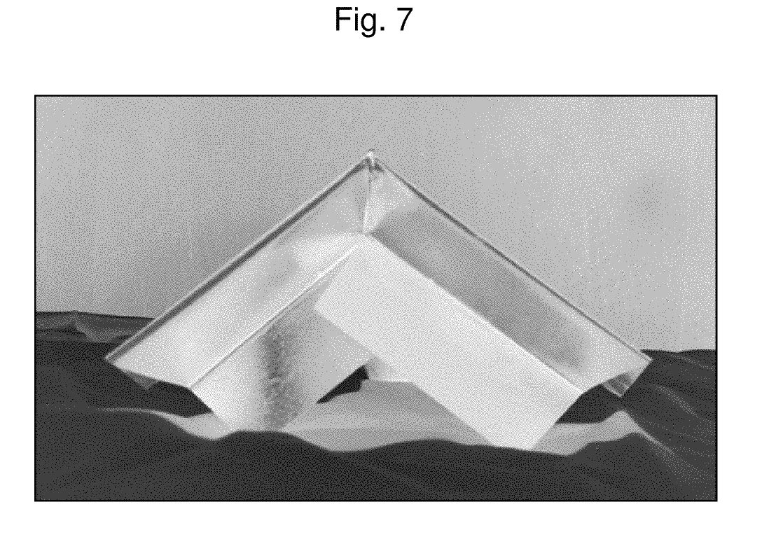

FIG. 6 represents another embodiment of the bird cap in which the cap is hooded by an overhang to provide added protection to shelter the roof peak. In this embodiment, hood panels 13a, 13b overhang the peak of the bird cap 9 and project forward over the peak 9 and face panels 8a, 8b. Hood panels 13a, 13b may be formed as an extension of the side panels 2a, 2b (not visible) that is folded about fold lines 14a, 14b to form the hood panels, and further about fold lines 16a, 16b to also form the face panels 8a, 8b. Alternately, extensions of the face panels 8a, 8b may be folded outward at fold lines 16a, 16b to form the hood panels 13a, 13b. In such embodiments of the bird cap the point of attachment is recessed beneath the hood panels. The hood panels culminate at an outwardly projected peak extension 9a. This extended area of the peak extension 9a hangs over the peak 9 and the face panels 8a, 8b. In this regard, the face panels 8a, 8b are typically flush against and continuous with the side walls (or the fascia of the side walls of the building structure) atop which the bird cap is installed. The hooded area formed by the peak extension 9a and the hood panels protect the peak 9 and the face panels 8a, 8b so that birds are further limited from perching on and pecking at the roof peak. FIG. 7 is a photograph of the configuration of the elements of a hooded bird cap.

In another aspect the invention comprises a method of preventing bird damage at the peak edges of a roof that includes (i) measuring the angle at the front of a roof peak; (ii) placing a bird cap over the front of the roof peak, the bird cap being comprised of two side panels, each comprising a front edge, a top edge and a side edge, wherein the two side panels are joined at the top edges thereof at an angle to form a peak; two face panels, each of which is attached to the front edge of one side panel, wherein the two face panels intersect at an intersection area, and further wherein the two face panels move cooperatively one in relation to the other to narrow or widen the angle of the peak; a tail portion which is formed as an extension of the side panels distally from the face panels, and wherein the length of each side panel is progressively shortened in relation to the length from the front edge to the tail portion; and a tail plate formed as the distal end of the tail portion; wherein the tail plate is aligned over the roof peak; and (iii) attaching the bird cap to the roof peak at the intersection of the two face panels. The hooded bird cap is installed in a similar manner, with attachment point located below the overhanging hooded panels. The methods of the invention installing the bird cap further comprise attaching the face panels to the opposed side panels of the cap at an acute angle that is slightly less than the angle formed by the roof side panels on either side of the roof peak. The acutely angled front of the peak of the bird cap facilitates installing the cap by apply pressure at a downward angle to attach the bird cap to the roof peak. In this respect, a bird cap that has the face panels positioned perpendicularly at a 90° angle in relation to the peak 9 of the bird cap could not be installed with a single frontal nail screw as can be achieved with the current invention. This is because the 90° would sit directly over the roof peak with no available area of displacement and the tail portion would be displaced upward and could not be fitted snugly over the roof peak (see FIG. 4). Because the front edges of the side panels are angled to form an acute angle of less than 90°, there is a slight displacement of the peak of the bird cap away from the tip of the roof peak itself. The downward pressure applied to the screw then moves through this displacement to facilitate the angled downward attachment of the bird cap to the roof peak.

The bird caps of the invention are constructed of a rigid material with limited flexibility. Preferred materials include but are not limited to non-corrosive metals such as aluminum, stainless steel or copper. The bird caps of the invention may also be painted to match or complement the roofing materials used in the construction of the roof.

In a method of installing a bird cap of the invention to prevent roof deterioration from the pecking of birds, the bird cap is placed over the roof peak and the face panels moved apart or pushed closer together to form an angle at the top of the bird cap that corresponds to the roof peak. A single screw of appropriate length to pass through the layers of the bird cap and the layers of the roof is then inserted through the intersection of the face panels at hole 12. The screw hole can be cut before the screw is installed, or the screw can be forced through the intersection area between the face panels using a powered screwdriver. The screw is inserted downward at an angle from a trajectory originating above the face panels, and it is further angled downward by the auguring motion of the screwdriver as it is screwed into place. For example, the angle of entry of the screw into screw hole 12 may be from about 30° to about 75° in relation to the face panels. This angled attachment of the screw applies a downward pressure along the tail portion of the bird cap, which in turn causes the tail plate to flex slightly, for example about 10° to about 45°, and press downward over the roof ridge. As a result, because of the advantageous placement of the elements of the bird cap and the cooperation between these elements, the tail portion and the tail plate are securely applied over the roof peak from one point of attachment. When applied in this manner, the tail portion does not lift, even in windy conditions. Another advantage of the bird cap and method of installation according to this invention, the tail portion and tail plate cover a section of the ridge vent at the roof peak, which is typically where the final layers of shingles are installed. Nails are used to secure each shingle in each layer up the slope of the roofing panels, and as a result the final shingles in the layer at the uppermost portion of the roof, in the area of the roof peak, has nail heads that are exposed and not covered by another layer of shingles. These nails have to be caulked so they will not become points of weakness that allow water entry. In some cases the junction between the upper shingle layers at the tops of the roofing panels is covered by a ridge vent, which spans the junction between the tops of the panels. The ridge vent has vents along its length to allow airflow from beneath the roof. However, the ridge vent is itself nailed in place and so also has exposed nails. The bird cap of the invention covers a length of the ridge, including the top of the ridge vent and the exposed nails at the top of the roof peak, which also further prevents the nails from being loosened and dislodged.

An advantage of the claimed invention is that the roof peak is securely protected from bird damage without nails or screws having to be inserted into the shingles and roof panels that form the roof gable and peak. In the present invention, only one screw is required to attach the bird cap to the roof structure.

The various embodiments of the invention may be used as a protective element on residential or commercial roofing structures. Multiple end caps may be used on a single building. The foregoing specification and examples provide an enabling description of the method of manufacture and comestible products of the invention. Many embodiments can be made without departing from the spirit and scope of the invention and this disclosure, including those represented by the appended claims.

### INDUSTRIAL APPLICABILITY

The devices and methods of the invention find applicability in the field of roofing construction, particularly in the construction or repair or preventive maintenance of roofs susceptible to bird damage such as asphalt or composite-shingled roofs.

1. A bird cap comprised of:
a. two side panels, each comprising a front edge, a top edge and a side edge, wherein the two side panels are joined at the top edges thereof at an angle to form a peak;
b. two face panels, each of which is attached to the front edge of one side panel, wherein the two face panels intersect at an intersection area, and further wherein the two face panels move cooperatively one in relation to the other to narrow or widen the angle of the peak;
c. a tail portion which is formed as an extension of the side panels distally from the face panels, and wherein the length of each side panel is progressively shortened in relation to the length from the front edge to the tail portion, such tail portion terminating in a flex zone; and
d. a tail plate formed as the distal end of the flex zone.

2. The bird cap of claim 1 further comprising a screw hole located within the intersection area for receiving an attachment screw and an attachment screw sized to pass through the screw hole.

3. The bird cap of claim 1 wherein the side edge of each side panel is curved or an angled straight edge.

4. The bird cap of claim 1 wherein the tail plate is wider than the width of the tail at the most distal end thereof.

5. The bird cap of claim 4 wherein the tail plate comprises side flanges.

6. The bird cap of claim 1, which is formed from a metal substrate with limited flexibility.

7. The bird cap of claim I further comprising two hood panels, each of which is attached to the front edge of a side panel and to the top edge of a face panel, and the hood panels are joined at a peak to form a hood that overhangs the intersection area between the face panels.

8. A method of preventing bird damage at the peak edges of a roof that includes:
a. measuring the angle at the front of a roof peak;
b. placing a bird cap over the front of the roof peak, the bird cap being comprised of:
two side panels, each comprising a front edge, a top edge and a side edge, wherein the two side panels are joined at the top edges thereof at an angle to form a peak;
two face panels, each of which is attached to the front edge of one side panel, wherein the two face panels intersect at an intersection area, and further wherein the two face panels move cooperatively one in relation to the other to narrow or widen the angle of the peak;
a tail portion which is formed as an extension of the side panels distally from the face panels, and wherein the length of each side panel is progressively shortened in relation to the length from the front edge to the tail portion, the tail portion terminating a flex zone; and
a tail plate formed as the distal end of the flex zone; wherein the tail plate is aligned over the roof peak; and
c. attaching the bird cap to the roof peak at the intersection of the two face panels.

9. The method of claim 8 wherein the bird cap is attached to the roof peak with a single screw.

10. The method of claim 8 wherein the side edge of each side panel of the bird cap is curved or an angled straight edge.

11. The method of claim 8 wherein the tail plate of the bird cap is wider than the width of the tail.

12. The method of claim 11 wherein the tail plate of the bird cap comprises side flanges.

13. The method of claim 9 wherein pressure is applied to the tail plate by pushing the bird cap downward at an angle as it is being attached to the roof peak.

14. The method of claim 8 wherein the bird cap is formed from a metal substrate with limited flexibility.
